(19) United States
(12) Patent Application Publication
(10) Pub. No.: US 2007/0084771 A1
(43) Pub. Date: Apr. 19, 2007

(54) Apparatus for supplying drinking water

(75) Inventors: Kazushige Watanabe, Gunma (JP); Miwako Ito, Saitama (JP)

Correspondence Address: BANNER & WITCOFF, 1001 G STREET N W, SUITE 1100, WASHINGTON, DC, 20001, US

(73) Assignee: SANDEN CORPORATION, Isesaki-shi (JP)

(21) Appl. No.: 10/578,669

(22) PCT Filed: Nov. 12, 2004
(86) PCT No.: PCT/JP04/16870

§ 371 Date: May 9, 2006

(30) Foreign Application Priority Data
Nov. 14, 2003 (JP) 2003-385367

(51) Int. Cl. C02F 1/02

(52) U.S. Cl. 210/175; 210/266; 422/26; 210/259; 204/660

(57) ABSTRACT

An apparatus for supplying drinking water has a construction such that a first branch pipe (P2) and a second branch pipe (P3) are connected to a water supply pipe (P1) in which tap water flows, a cold water generating tank (3) is provided in the first branch pipe (P2), and the second branch pipe (P3) is provided with an ion exchange device (4) and a hot water generating tank (5). When the tap water is allowed to flow in the first branch pipe (P2), cold water is generated in the cold water generating tank (3). Also, when the tap water is allowed to flow in the second branch pipe (P3), the tap water is softened by the ion exchange device (4), and is further heated in the hot water generating tank (5). Therefore, not only cold water can be supplied but also hot water from which mineral components are removed can be supplied.

### TECHNICAL FIELD

The present invention relates to an apparatus for supplying drinking water which supplies drinking water after cooling or heating.

### BACKGROUND ART

Conventionally, as the apparatus for supplying drinking water of this type, an invention described in Patent Document 1 has been known.

This apparatus for supplying drinking water has a drinking water storage portion in which mineral water is stored, and the mineral water is supplied from the drinking water storage portion into a cold water tank or a hot water tank. The mineral water supplied into the cold water tank is cooled by a cooler. Also, the mineral water supplied into the hot water tank is heated by a heater. When a cold water pouring-out valve of the cold water tank is opened, cold water is poured out through a nozzle, and when a hot water pouring-out valve of the hot water tank is opened, hot water is poured out through a nozzle.

Patent Document 1: Japanese Patent Publication 2000-85893

### DISCLOSURE OF THE INVENTION

### Problems to be Solved by the Invention

If the mineral component contained in mineral water (hard water) is calcium (Ca), the mineral water is effective for pregnant women, nursing women, or persons of weak constitution. Also, if the mineral component is magnesium (Ma), the mineral water is effective for pregnant women or persons engaging in hard labor.

However, when such mineral water is given to an infant, so-called water poisoning may occur, so that the mineral water is unsuitable as water for nursing.

In view of the above conventional problem, an object of the present invention is to provide an apparatus for supplying drinking water capable of supplying not only cold water but also hot water from which mineral components are removed.

### MEANS FOR SOLVING THE PROBLEMS

To solve the above problem, an apparatus for supplying drinking water in accordance with the present invention is constructed so as to have a water supply pipe capable of conducting raw water such as tap water and bottled natural water; a first branch pipe and a second branch pipe which are divided from the water supply pipe into two and can conduct the raw water in the water supply pipe; a cold water generating tank capable of cooling the raw water conducted from the first branch pipe; water softening means capable of removing hardness components from the raw water conducted from the second branch pipe; and hot water generating tank capable of heating soft water generated by the water softening means.

According to the present invention, when the raw water is allowed to flow in the first branch pipe, cold water is generated in the cold water generating tank, thereby cold water is supplied. Also, when the raw water is allowed to flow in the second branch pipe, soft water is generated by the water softening means, and further the soft water turns to hot water in the hot water generating tank. Thereby, heated soft water is supplied.

### EFFECTS OF THE INVENTION

According to the present invention, both cold water and softened hot water can be supplied, so that a desired drinking water can be obtained as necessary.

### BRIEFLY DESCRIBE OF THE DRAWINGS

FIG. 1 is a water circuit diagram showing an apparatus for supplying drinking water in accordance with a first embodiment;

FIG. 2 is a front sectional view of a mineral water generating unit;

FIG. 3 is a side sectional view of a mineral water generating unit;

FIG. 4 is a partially broken sectional view of an ion exchange device;

FIG. 5 is a water circuit diagram showing an apparatus for supplying drinking water in accordance with a second embodiment;

FIG. 6 is a partially broken sectional view of an activated carbon filter device in accordance with a second embodiment;

FIG. 7 is a partially broken sectional view of a reverse osmosis membrane device in accordance with a third embodiment;

FIG. 8 is a water circuit diagram showing an apparatus for supplying drinking water in accordance with a fourth embodiment;

FIG. 9 is a water circuit diagram showing an apparatus for supplying drinking water in accordance with a fifth embodiment;

FIG. 10 is a water circuit diagram showing an apparatus for supplying drinking water in accordance with a sixth embodiment;

FIG. 11 is a water circuit diagram showing an apparatus for supplying drinking water in accordance with a seventh embodiment;

FIG. 12 is a water circuit diagram showing an apparatus for supplying drinking water in accordance with an eighth embodiment;

FIG. 13 is a flowchart showing drive control of an apparatus for supplying drinking water in accordance with an eighth embodiment;

FIG. 14 is a water circuit diagram showing an apparatus for supplying drinking water in accordance with a ninth embodiment;

FIG. 15 is a water circuit diagram showing an apparatus for supplying drinking water in accordance with a tenth embodiment;

FIG. 16 is a partially omitted front view showing an example in which a sterilizing/cleaning chamber in accordance with an eleventh embodiment is provided; and

FIG. 17 is a partially omitted plan view showing an example in which a sterilizing/cleaning chamber in accordance with an eleventh embodiment is provided.

### DESCRIPTION OF SYMBOLS

1 mineral water generating unit
2 pump
3 cold water generating tank
4 ion exchange device
5 hot water generating tank
6 activated carbon filter device
7 reverse osmosis membrane device
8 steam generator
9 steam cooler
10 water tank
13, 15, 17 cleaning/sterilizing device
18 sterilizer
P1 water supply pipe
P2 first branch pipe
P3 second branch pipe

### BEST MODE FOR CARRYING OUT THE INVENTION

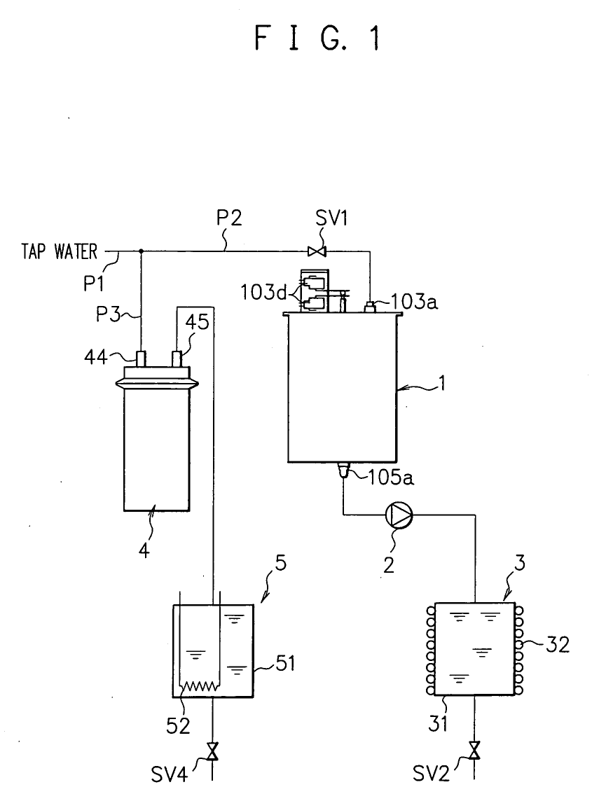

FIGS. 1 to 4 shows a first embodiment of an apparatus for supplying drinking water in accordance with the present invention.

First, a water circuit of the apparatus for supplying drinking water will be explained with reference to FIG. 1. The apparatus for supplying drinking water has a water supply pipe P1 for feeding tap water. To the downstream end of the water supply pipe P1, a first branch pipe P2 and a second branch pipe P3a are connected. In the first branch pipe P2, a first water supply valve SV1, a mineral water generating unit 1, a pump 2, a cold water generating tank 3, and a cold water supply valve SV2 are provided in that order along the flow of raw water. On the other hand, in the second branch pipe P3, an ion exchange device 4, a hot water generating tank 5, and a hot water supply valve SV4 are provided in that order along the flow of raw water.

The mineral water generating unit 1 has a flat box shaped tank body 101, and the interior thereof is partitioned into upper and lower portions via a permeable partitioning plate 102. Above the partitioning plate 102, a storage tank 103 into which tap water is supplied is formed, and below the partitioning plate 102, an electrolytic bath 104 for electrolyzing water is formed.

The upper plate of the storage tank 103 is provided with a water conducting cylinder 103a for conducting tap water. The tap water flowing in the water supply pipe P1 is conducted into the storage tank 103 through the water conducting cylinder 103a. Also, the storage tank 103 is provided with a water level detector 103b. A float 103c of the water level detector 103b moves vertically in accordance with the water level in the storage tank 103, and a micro switch 103d detects the vertical position of the float 103c. Based on the detection signal of the micro switch 103d, the first water supply valve SV1 is controlled so as to be opened and closed, by which the water level in the storage tank 103 is kept at a predetermined level. Also, a guide plate 103e is provided in the storage tank 103. The tap water flowing into the water conducting cylinder 103a is guided toward the center by the guide plate 103e, by which the tap water is conducted over the whole of the storage tank 103. Reference character 103f denotes an overflow pipe for draining water exceeding an allowable quantity.

In the electrolytic bath 104, a plurality of mineral eluting material 104a each packed in a flat case and a plurality of paired positive and negative electrodes 104b and 104c are arranged alternately. As the mineral eluting material 104a, coral sand, granite porphyry, mineral stone, etc., which are ground into particulates or powder, are used. Also, a DC voltage is applied to between the electrodes 104b and 104c, by which mineral contents are eluted from the mineral eluting material 104a arranged between the electrodes 104b and 104c.

A terminal 104d of each electrode 104b, 104c penetrates the partitioning plate 102, and protrudes from the upper plate of the storage tank 103. Also, the tip end of the terminal 104d is connected to a power source.

Under the electrolytic bath 104, a flow joining chamber 105 is provided. In the flow confluence chamber 105, mineral water generated in the electrolytic bath 104 flows together. Also, the mineral water flowing into the flow confluence chamber 105 flows to the pump 2 side through a conducting cylinder 105a.

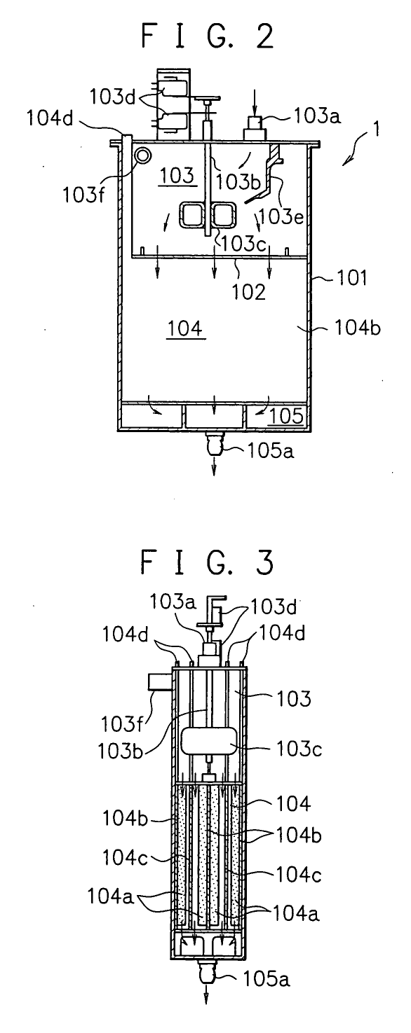

By this configuration, the mineral water is supplied by the flow of tap water from the storage tank 103 to the electrolytic bath 104 and to the flow confluence chamber 105 as indicated by arrows in FIGS. 2 and 3.

The cold water generating tank 3 is configured so that a coil evaporator 32 is provided on the outside surface of a tank body 31. Into the coil evaporator 32, a refrigerant is circulated from a cooler, not shown, so that the interior of the tank body 31 is cooled by the circulating refrigerant. Also, when the pump 2 is driven, the mineral water in the mineral water generating unit 1 is supplied to the cold water generating tank 3. By the operation for supplying mineral water and the operation for cooling mineral water, cooled mineral water is generated in the tank body 31. Also, when the pump 2 is driven and the cold water supply valve SV2 is opened, the mineral water is supplied from the cold water generating tank 3.

The ion exchange device 4 is configured so that as shown in FIG. 4, a device body 41 is filled with a cation-exchange resin 42, for example, a Na-type strongly acidic cation-exchange resin. Also, the interior of the device body 41 is partitioned into right and left portions by a partitioning plate 48 except for the lower part thereof, namely, two chambers are formed in the device body 41. One chamber of the device body 4l has an inlet 44 through which the tap water flows into the chamber, and the other chamber thereof has an outlet 45 through which the tap water flows out of the chamber. Thereby, the tap water that flows in through the inlet 44 is conducted to one chamber, then being conducted to the other chamber, and flows out through the outlet 45. The tap water is softened during the time when it flows in the chambers. Specifically, calcium ions and magnesium ions contained in the tap water are ion exchanged for Na ions of the Na-type strongly acidic cation-exchange resin, by which the tap water is softened.

The hot water generating tank 5 is configured so that a heater 52 is provided in a tank body 51. By energizing the heater 52, the water in the tank body 51 is heated. Also, the tap water having been softened in the ion exchange device 4 is conducted into the hot water generating tank 5. Thereby, heated soft water is generated in the hot water generating tank 5. Also, when the pump 2 is driven and the hot water supply valve SV4 is opened, softened hot water is supplied from the hot water generating tank 5.

According to this embodiment, the tap water flowing in the water supply pipe P1 is supplied into the mineral generating unit 1 through the first branch pipe P2, and mineral water is generated. This mineral water is cooled in the cold water generating tank 3, by which cooled mineral water is supplied. On the other hand, the tap water flowing in the water supply pipe P1 is supplied into the ion exchange device 4 through the second branch pipe P3, and is softened. The softened tap water is heated in the hot water generating tank 5, by which softened hot water is supplied.

Therefore, mineral cold water that is suitable for pregnant women can be supplied, and also softened hot water suitable for nursing and tea brewing can be supplied. That is, suitable water can be supplied in accordance with the needs in each situation.

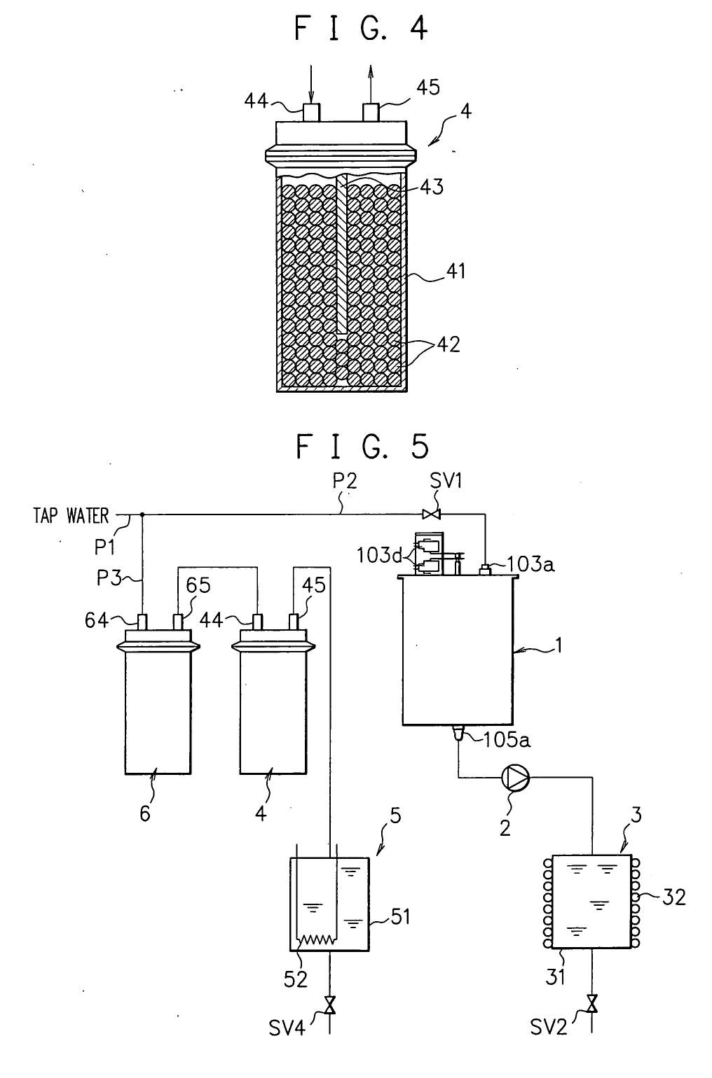

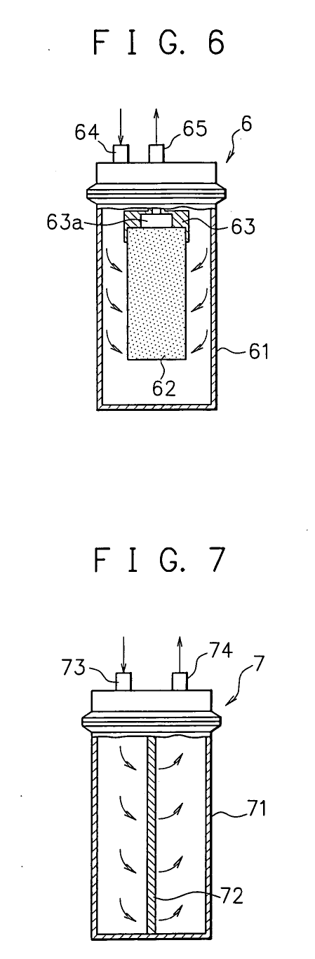

FIGS. 5 and 6 show a second embodiment of an apparatus for supplying drinking water in accordance with the present invention. This embodiment is characterized in that an activated carbon filter device 6 containing activated carbon is added to the apparatus for supplying drinking water of the first embodiment. The same reference characters are applied to elements equivalent to those in the first embodiment, and explanation of the configuration thereof is omitted.

The activated carbon filter device 6 is provided in an intermediate position of the second branch pipe P3 between a second water supply valve SV3 and the ion exchange device 4 as shown in FIG. 5. The construction of the activated carbon filter device 6 is as shown in FIG. 6. In FIG. 6, the activated carbon filter device 6 is configured so that a filter 62 in which activated carbon are mixed is arranged in the center of a tank body 61. The filter 62 is installed to the tank body 61 by being suspended by a holder 63 having a water path 63a in the center thereof. The surrounding portion of the filter 62 communicates with an inlet 64, and the water path 63a communicates with an outlet 65. Therefore, as indicated by solid-line arrows in FIG. 6, the tap water flowing into the tank body 61 through the inlet 64 flows in the tank body 61, and passes through the filter 62. When the tap water passes through the filter 62, not only dust floating in the tap water is trapped but also mold smell and chlorine smell are removed, by which the tap water is purified. The purified water flows in the water path 63a,and is discharged through the outlet 65 communicating with the water path 63a.

According to this embodiment, cooled mineral water and heated soft water are supplied as in the first embodiment, and further the soft water is purified. Therefore, a nursing drinking water best suitable for infants with low resistance is supplied. Other configurations and operation are the same as those in the first embodiment.

FIG. 7 shows a third embodiment of an apparatus for supplying drinking water in accordance with the present invention. Although the ion exchange device 4 is used as water softening means in the first and second embodiments, a reverse osmosis membrane device 7 is used in this embodiment. This embodiment is the same as the second embodiment except that the ion exchange device 4 is replaced with the reverse osmosis membrane device 7, so that the same reference characters are applied to elements equivalent to those in the second embodiment, and explanation of the configuration thereof is omitted.

The reverse osmosis membrane device 7 is configured so that a reverse osmosis membrane filter 72 is arranged in a device body 71. The reverse osmosis membrane filter 72, which consists of, for example, a cellulose acetate reverse osmosis membrane, keeps mineral components (calcium components, magnesium components, etc.) from passing through, and allows water to pass through. Also, the interior of the device body 71 is partitioned into right and left portions by the reverse osmosis membrane filter 72, by which two chambers are formed. One chamber of the device body 71 communicates with an inlet 73 for tap water, and the other chamber communicates with an outlet 74 for tap water.

According to this embodiment, as indicated by solid-line arrows, the tap water fed from the activated carbon filter device, not shown, flows into the device body 71 through the inlet 73, passing through the reverse osmosis membrane filter 72, and is discharged through the outlet 74. When the tap water passes through the reverse osmosis membrane filter 72, mineral components are kept from passing through, by which the tap water is softened. Other configurations and operation are the same as those in the second embodiment.

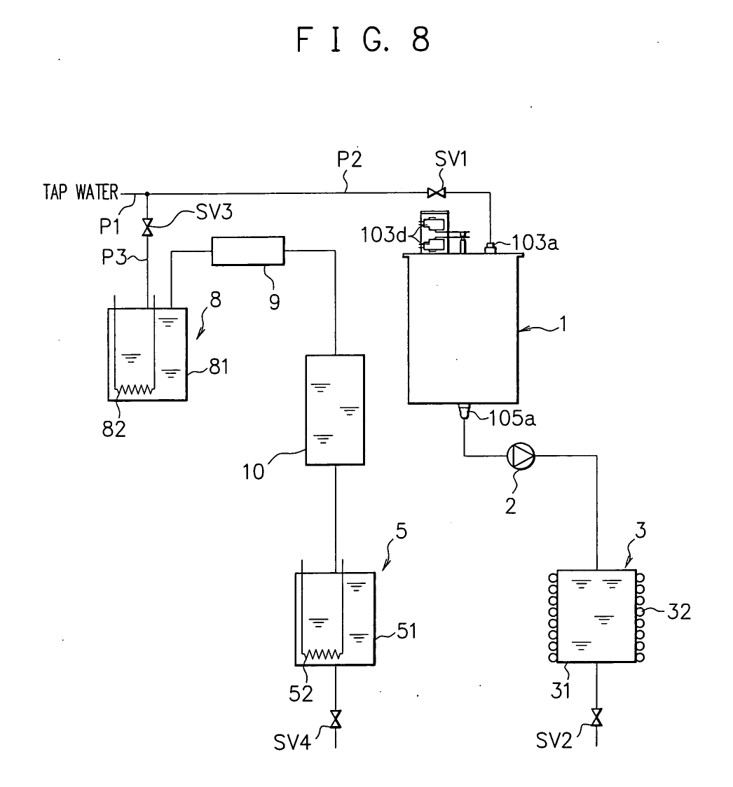

FIG. 8 shows a fourth embodiment of an apparatus for supplying drinking water in accordance with the present invention. In this embodiment, a steam generator 8, a steam cooler 9, and a water tank 10 are used as water softening means. The same reference characters are applied to elements equivalent to those in the first embodiment, and explanation of the configuration thereof is omitted.

The steam generator 8, which is provided on the downstream side of the second water supply valve SV3, has a construction in which a heater 82 is incorporated in a generator body 81. The steam cooler 9, which is provided on the downstream side of the steam generator 8, is formed by a box that is long sideways and is configured so that steam is cooled by the temperature around the steam cooler 9 when the steam passes through the interior of the box. The water tank 10, which is provided on the downstream side of the steam cooler 9, stores the water having been condensed in the steam cooler 9. The condensed water stored in the water tank 10 is conducted into the hot water generating tank 5.

According to this embodiment, the tap water is heated into steam in the steam generator 8. At this time, calcium components and magnesium components contained in the tap water remain in the steam generator 8. Also, the steam is condensed in the steam cooler 9, by which soft water is generated. Although the soft water generated in the steam cooler 9 is once stored in the water tank 10 in this embodiment, the soft water generated in the steam cooler 9 may be supplied directly to the hot water generating tank 5. Other configurations and operation are the same as those in the first embodiment.

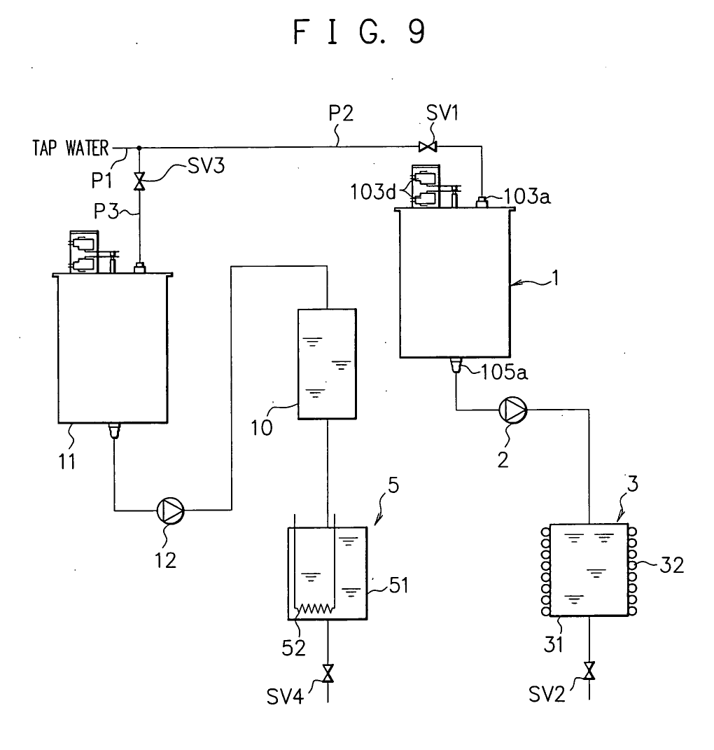

FIG. 9 shows a fifth embodiment of an apparatus for supplying drinking water in accordance with the present invention. In this embodiment, a mineral depositing device 11, a pump 12, and the water tank (mineral removing tank) 10 are provided as water softening means. The same reference characters are applied to elements equivalent to those in the fourth embodiment, and explanation of the configuration thereof is omitted.

The mineral depositing device 11 is provided on the downstream side of the second water supply valve SV3. Also, since the construction of the mineral depositing device 11 is the same as that of the mineral water generating unit 1 explained in the first embodiment, a figure showing the internal construction thereof is omitted. The mineral depositing device 11 has the same construction as that of the mineral water generating unit 1. Specifically, the mineral depositing device 11 has an electrolytic bath into which tap water is supplied, mineral eluting material from which mineral components are eluted, and pairs of positive and negative electrodes for applying a DC voltage.

A difference between the mineral depositing device 11 and the mineral water generating unit 1 is that a current value to each electrode differs. Specifically, the value of current carried to the electrode of the mineral depositing device 11 in accordance with this embodiment is larger than the value of current carried to the electrode of the mineral water generating unit 1. When the current value is increased, the quantity of elution from the mineral effluent increases, and accordingly the pH value in the tank body increases. When the pH value reaches a predetermined value, the quantity of elution of mineral decreases suddenly, and the mineral components contained in the water in the tank body is inversely deposited. By utilizing this phenomenon, the tap water flowing into the mineral depositing device 11 is softened.

The pump 12 forcedly supplies the soft water generated in the mineral depositing device 11 into the water tank 10. The soft water mixed in a mineral depositing section is stored in the water tank 10, and mineral deposits remain in the water tank 10.

According to this embodiment, soft water is generated in the mineral depositing device 11, and this soft water is fed to the water tank 10 by the pump 12 and is supplied into the hot water generating tank 5. Other configurations and operation are the same as those in the first embodiment.

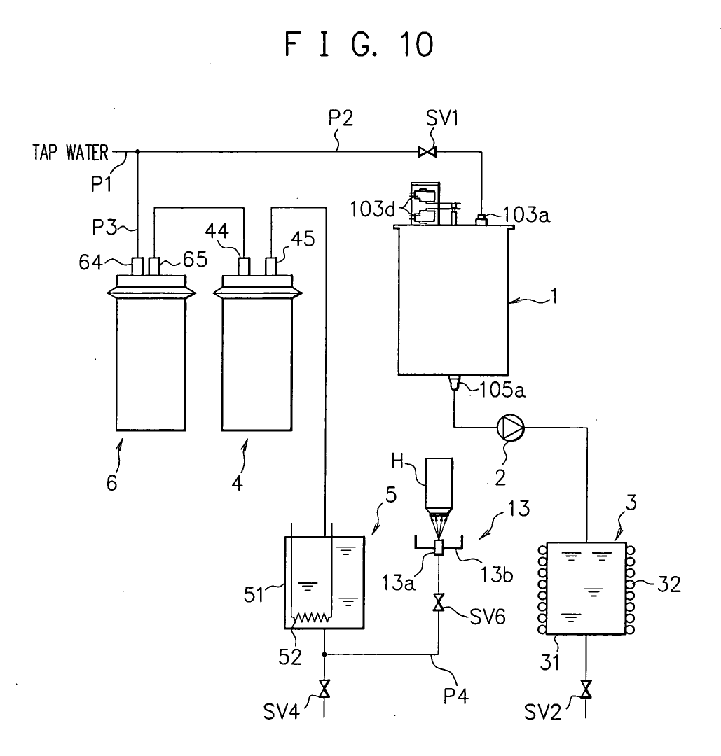

FIG. 10 shows a sixth embodiment of an apparatus for supplying drinking water in accordance with the present invention. In this embodiment, a cleaner 13 is provided in addition to the apparatus for supplying drinking water in accordance with the second embodiment shown in FIG. 5. The same reference characters are applied to elements equivalent to those in the second embodiment, and explanation of the configuration thereof is omitted.

The cleaner 13 has a cleaning branch pipe P4 branching from the second branch pipe P3 between the hot water generating tank 5 and the hot water supply valve SV4. A spray nozzle 13a is provided at the tip end of the cleaning branch pipe P4, and a cleaning water supply valve SV6 is provided in an intermediate position of the cleaning branch pipe P4. Also, a water receiver 13b is provided around the spray nozzle 13a.

According to this embodiment, by opening the cleaning water supply valve SV6, the hot water in the hot water generating tank 5 is sprayed as indicated by arrows through the cleaning branch pipe P4 and the spray nozzle 13a. Therefore, when a beverage receptacle, for example, a nursing bottle H brought by a user is placed toward the spray nozzle 13a as shown in FIG. 10, soft water is sprayed into the nursing bottle H, and thereby the nursing bottle H can be cleaned. Other configurations and operation are the same as those in the second embodiment.

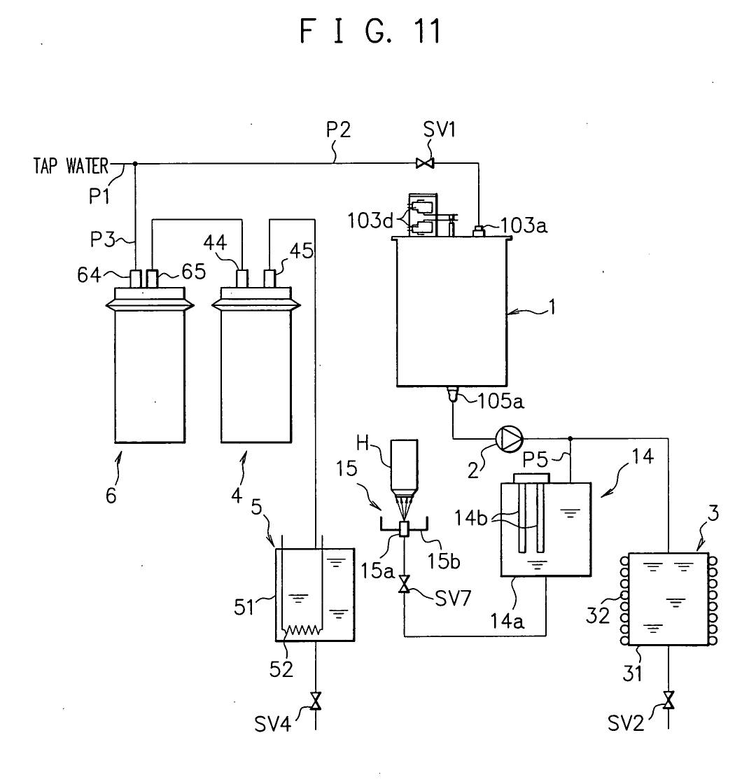

FIG. 11 shows a seventh embodiment of an apparatus for supplying drinking water in accordance with the present invention. In this embodiment, a chlorine generator 14 and a cleaning/sterilizing device 15 are provided in addition to the apparatus for supplying drinking water in accordance with the second embodiment shown in FIG. 5. The same reference characters are applied to elements equivalent to those in the second embodiment, and explanation of the configuration thereof is omitted.

This apparatus for supplying drinking water has a cleaning/sterilizing branch pipe P5 branching from the first branch pipe P2 between the pump 2 and the cold water generating tank 3. In the cleaning/sterilizing branch pipe P5, the chlorine generator 14 is provided. The chlorine generator 14, which is configured by arranging a pair of chlorine generating electrodes 14b in a closed vessel 14a, generates hypochlorous acid by means of the reaction of chlorine ion by applying a DC voltage to between the chlorine generating electrodes 14b.

A spray nozzle 15a of the cleaning/sterilizing device 15 is provided at the tip end of the cleaning/sterilizing branch pipe P5, and a cleaning water supply valve SV7 is provided in an intermediate position of the cleaning/sterilizing branch pipe P5. Also, a water receiver 15b is provided around the spray nozzle 15a.

According to this embodiment, by opening the cleaning water supply valve SV7, hypochlorous acid water in the chlorine generator 14 is sprayed as indicated by arrows through the cleaning/sterilizing branch pipe P5 and the spray nozzle 15a. As a result, a nursing bottle H can be cleaned and sterilized. Other configurations and operation are the same as those in the second embodiment.

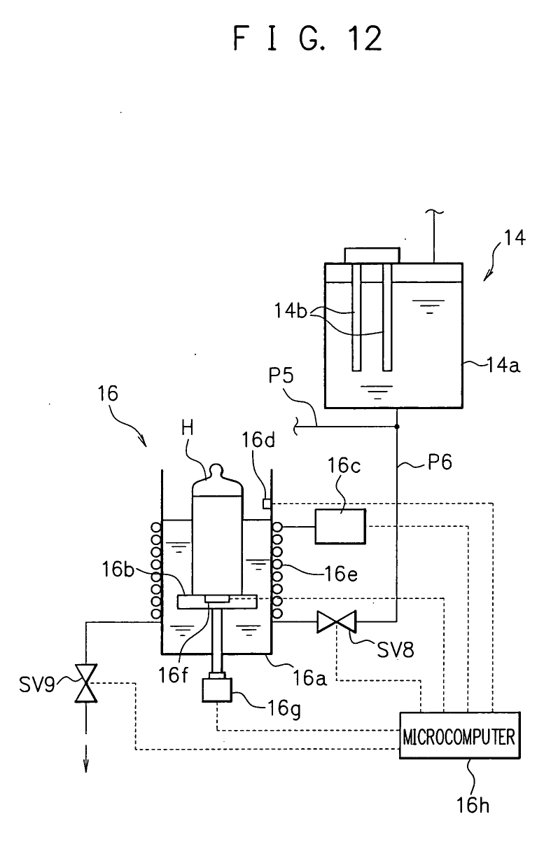

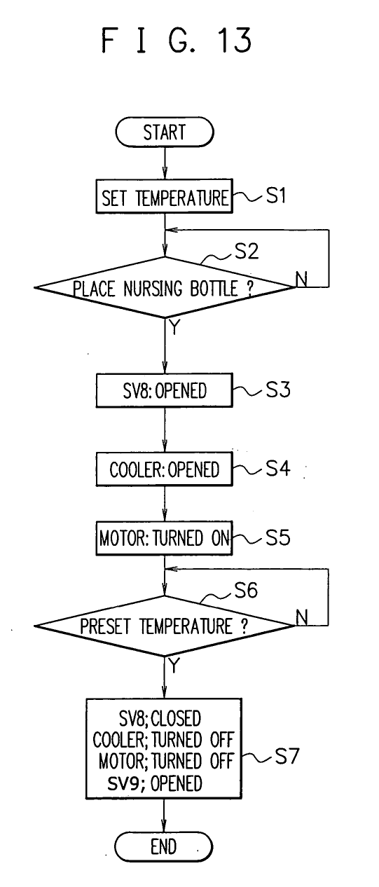

FIGS. 12 and 13 show an eighth embodiment of an apparatus for supplying drinking water in accordance with the present invention. In this embodiment, an automatic cooler is provided which can cool a hot beverage received by a nursing bottle H to a desired temperature. The same reference characters are applied to elements equivalent to those in the seventh embodiment, and explanation of the configuration thereof is omitted.

Specifically, the automatic cooler 16 has a water receiving tank 16a, a rotary stand 16b on which a nursing bottle H is placed, a cooling device 16c for cooling water in the tank 16a, a cooling branch pipe P6 for conducting the hypochlorous acid water generated in the chlorine generator 14, and an infrared ray sensor 16d for sensing the temperature of a nursing bottle H placed in the tank 16a.

Around the tank 16a, a cooling coil 16e of the cooling device 16c is wound, and thereby the water in the tank 16a is cooled by a refrigerant circulating in the cooling coil 16e. A piezoelectric sensor 16f embedded in the rotary stand 16b checks whether or not a nursing bottle H has been placed on the rotary stand 16b. Also, when the piezoelectric sensor 16f detects the nursing bottle H, a motor 16g is driven, so that the rotary stand 16b is rotated. The cooling branch pipe P6 branches from an intermediate position of the cleaning/sterilizing branch pipe P5. An inlet valve SV8 is provided on the upstream side of the tank 16a, and an exhaust valve SV9 is provided on the downstream side of the tank 16a.

The automatic cooler 16 configured as described above is controlled by a microcomputer 16h. The control flow is explained with reference to FIG. 13.

First, the temperature of nursing bottle H is set at a certain value (for example, a temperature suitable for nursing of 35° C.) by a temperature setting device, not shown (S1). Next, based on a detection signal of the piezoelectric sensor 16f, the microcomputer 16 judges whether or not a nursing bottle H has been placed on the rotary stand 16b (S2). When the microcomputer 16 judges, in Step S2, that the nursing bottle H has been placed, the inlet valve SV8 is opened (S3), the cooler 16c is driven (S4), and further the motor 16g is driven (S5). Thereby, a nursing beverage received in the nursing bottle H is cooled while the nursing bottle H is rotated.

During the cooling operation of the nursing bottle H, the microcomputer 16h monitors the nursing bottle temperature sensed by the infrared ray sensor 16d to check whether or not the temperature has become the preset temperature (S6). When the microcomputer 16h judges that the nursing bottle temperature has become the preset temperature, the inlet valve SV8 is closed, the cooler 16c is stopped, and further the motor 16g is stopped. Furthermore, the exhaust valve SV9 is opened for a predetermined period of time (S7). Thereby, the water in the tank 16a is exhausted, and the cooling operation of the nursing bottle H is finished.

According to this embodiment, the nursing beverage received by the nursing bottle H can be cooled to a proper temperature. Also, since the water stored in the tank 16a is hypochlorous acid water, the outside surface of the nursing bottle H is sterilized and cleaned. Other configurations and operation are the same as those in the seventh embodiment.

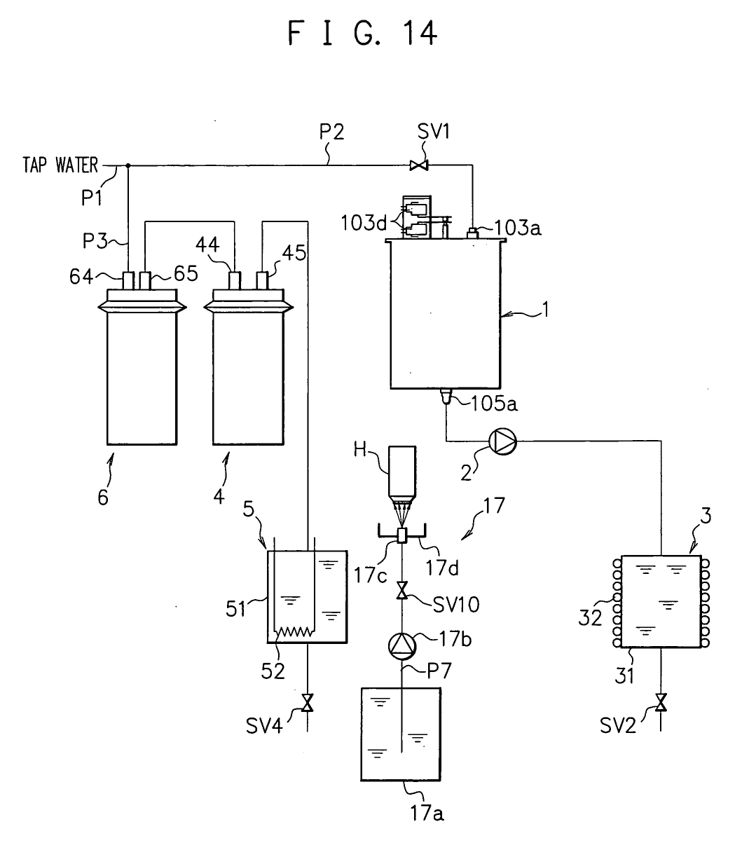

FIG. 14 shows a ninth embodiment of an apparatus for supplying drinking water in accordance with the present invention. In this embodiment, a cleaning/sterilizing device 17 using an alcohol solution is provided in addition to the apparatus for supplying drinking water in accordance with the second embodiment shown in FIG. 5. The same reference characters are applied to elements equivalent to those in the second embodiment, and explanation of the configuration thereof is omitted.

The cleaning/sterilizing device 17 has a tank 17a for storing an alcohol solution, a conducting pipe P7 for conducting the alcohol solution from the tank 17a to the upside, a pump 17b for pumping the alcohol solution in the tank 17a,an alcohol supply valve SV10 for controlling the water flow in the conducting pipe P7, a spray nozzle 17c provided at the tip end of the conducting pipe P7, and an alcohol receiver 17d for receiving the sprayed alcohol solution.

According to this embodiment, when the alcohol supply valve SV7 is opened and the pump 17c is driven, the alcohol solution in the tank 17a is sprayed as indicated by arrows through the conducting pipe P7 and the spray nozzle 17c. Thereby, a nursing bottle H can be cleaned and sterilized. Other configurations and operation are the same as those in the second embodiment.

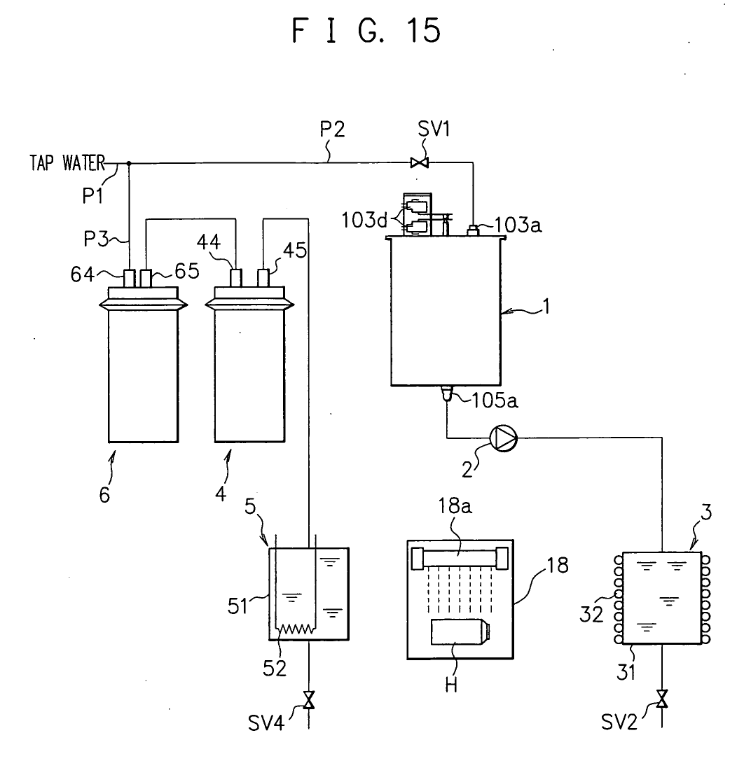

FIG. 15 shows a tenth embodiment of an apparatus for supplying drinking water in accordance with the present invention. In this embodiment, a sterilizer 18 using ultraviolet rays is provided in addition to the apparatus for supplying drinking water in accordance with the second embodiment shown in FIG. 5. The same reference characters are applied to elements equivalent to those in the second embodiment, and explanation of the configuration thereof is omitted.

The sterilizer 18 has an ultraviolet lamp 18a. By applying ultraviolet rays (indicated by broken lines) generated from the ultraviolet lamp 18a, a nursing bottle H is sterilized by ultraviolet. Other configurations and operation are the same as those in the second embodiment.

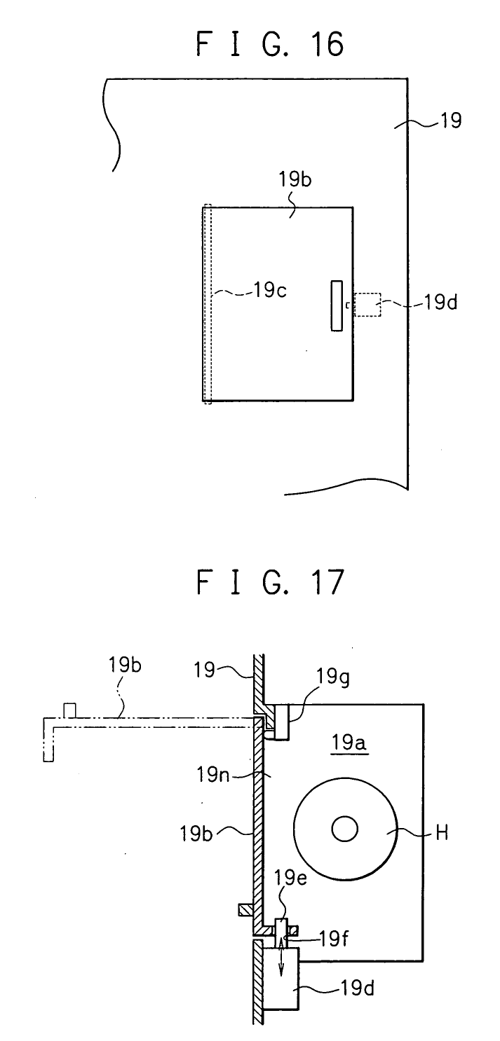

FIGS. 16 and 17 show an eleventh embodiment of an apparatus for supplying drinking water in accordance with the present invention. This embodiment shows an example in which a chamber for cleaning and sterilizing a water receptacle such as a nursing bottle H is provided separately.

Specifically, a cleaning/sterilizing chamber 19a is provided in a housing 19 arranged in the apparatus for supplying drinking water. The front face of the cleaning/sterilizing chamber 19a is opened and closed freely with a door 19b. Also, the door 19b is pivotally supported by a hinge 19c, and a hook hole 19f with which a plunger 19e of a locking device (solenoid) 19d engages freely is formed on the open end side of the door 19b. In a position close to the base end of the door 19b, a micro switch 19g is provided to detect the opening and closing of the door 19b.

According to this embodiment, when the door 19b closes a gateway 19h of the cleaning/sterilizing chamber 19a as indicated by a solid line in FIG. 17, the closed condition of the door 19b is detected, and the plunger 19e of the locking device 19d engages with the hook hole 19f, by which the door 19b is locked. On the other hand, when the cleaning and sterilizing operation is finished, the plunger 19e of the locking device 19d retracts, and thereby the lock is released. Thereby, the door 19b can be opened as indicated by a two-dot chain line in FIG. 17.

According to this embodiment, when a water receptacle such as a nursing bottle H is cleaned and sterilized, the cleaning/sterilizing chamber 19a is closed by the door 19b. As a result, good hygiene is carried out because a cleaning/sterilizing solution (water) does not scatter to the outside. Other configurations and operation are the same as those in the first embodiment.

Although an example in which a nursing bottle H is cleaned and sterilized has been shown in the sixth to eleventh embodiments, the configuration is not limited to this example. For example, a receptacle (bottle) for stored drinking water can be cleaned and sterilized.

### INDUSTRIAL APPLICABILITY OF THE INVENTION

The apparatus for supplying drinking water in accordance with the present invention can be used for not only a business beverage dispenser for beverage sale but also a household beverage supply device that is used to upgrade water quality of household drinking water.

What is claimed is:

1. An apparatus for supplying drinking water comprising:
a water supply pipe capable of conducting raw water such as tap water and bottled natural water;
a first branch pipe and a second branch pipe which are divided from the water supply pipe into two and can conduct the raw water in the water supply pipe;
a cold water generating tank capable of cooling the raw water conducted from the first branch pipe;
a water softening means capable of removing hardness components from the raw water conducted from the second branch pipe; and
a hot water generating tank capable of heating soft water generated by the water softening means.

2. The apparatus for supplying drinking water according to claim 1, wherein the first branch pipe is provided with a mineral water generating unit in which mineral components are added to the raw water.

3. The apparatus for supplying drinking water according to claim 1, wherein the water softening means has an activated carbon filter device containing activated carbon and an ion exchange device provided with a cation-exchange resin.

4. The apparatus for supplying drinking water according to claim 2, wherein the water softening means has an activated carbon filter device containing activated carbon and an ion exchange device provided with a cation-exchange resin.

5. The apparatus for supplying drinking water according to claim 1, wherein the water softening means has an activated carbon filter device containing activated carbon and a reverse osmosis membrane filter device for keeping mineral components from passing through.

6. The apparatus for supplying drinking water according to claim 2, wherein the water softening means has an activated carbon filter device containing activated carbon and a reverse osmosis membrane filter device for keeping mineral components from passing through.

7. The apparatus for supplying drinking water according to claim 1, wherein the water softening means has a steam generator for generating steam by heating the raw water and a steam cooler for condensing steam generated in the steam generator.

8. The apparatus for supplying drinking water according to claim 2, wherein the water softening means has a steam generator for generating steam by heating the raw water and a steam cooler for condensing steam generated in the steam generator.

9. The apparatus for supplying drinking water according to claim 1, wherein the water softening means has:
a mineral depositing device having an electrolytic bath for storing the raw water conducted from the second branch pipe, a mineral eluting material arranged in the electrolytic bath, and a pair of positive and negative electrodes for applying a DC voltage to the raw water in the electrolytic bath; and
a mineral removing tank for trapping mineral deposits formed in the mineral depositing device.

10. The apparatus for supplying drinking water according to claim 2, wherein the water softening means has:
a mineral depositing device having an electrolytic bath for storing the raw water conducted from the second branch pipe, a mineral eluting material arranged in the electrolytic bath, and a pair of positive and negative electrodes for applying a DC voltage to the raw water in the electrolytic bath; and
a mineral removing tank for trapping mineral deposits formed in the mineral depositing device.

11. The apparatus for supplying drinking water according to claim 1, wherein the apparatus for supplying drinking water has a cleaning/sterilizing device for cleaning and sterilizing a water receptacle such as a nursing bottle by using hot water generated in the hot water generating tank.

12. The apparatus for supplying drinking water according to claim 2, wherein the apparatus for supplying drinking water has a cleaning/sterilizing device for cleaning and sterilizing a water receptacle such as a nursing bottle by using hot water generated in the hot water generating tank.

13. The apparatus for supplying drinking water according to claim 1, wherein the apparatus for supplying drinking water has:
a cleaning/sterilizing branch pipe branching from the first branch pipe;
a chlorine generator for containing chlorine in the water conducted to the cleaning/sterilizing branch pipe; and
a cleaning/sterilizing device for cleaning and sterilizing a water receptacle such as a nursing bottle by using chlorine-containing water generated in the chlorine generator.

14. The apparatus for supplying drinking water according to claim 2, wherein the apparatus for supplying drinking water has:
a cleaning/sterilizing branch pipe branching from the first branch pipe;
a chlorine generator for containing chlorine in the water conducted to the cleaning/sterilizing branch pipe; and
a cleaning/sterilizing device for cleaning and sterilizing a water receptacle such as a nursing bottle by using chlorine-containing water generated in the chlorine generator.

15. The apparatus for supplying drinking water according to claim 1, wherein the apparatus for supplying drinking water has a cleaning/sterilizing device for cleaning and sterilizing a water receptacle such as a nursing bottle by using a cleaning/sterilizing solution containing at least an alcohol solution.

16. The apparatus for supplying drinking water according to claim 2, wherein the apparatus for supplying drinking water has a cleaning/sterilizing device for cleaning and sterilizing a water receptacle such as a nursing bottle by using a cleaning/sterilizing solution containing at least an alcohol solution.

17. The apparatus for supplying drinking water according to claim 1, wherein the apparatus for supplying drinking water has an ultraviolet sterilizer for sterilizing a water receptacle such as a nursing bottle by ultraviolet.

18. The apparatus for supplying drinking water according to claim 2, wherein the apparatus for supplying drinking water has an ultraviolet sterilizer for sterilizing a water receptacle such as a nursing bottle by ultraviolet.

19. The apparatus for supplying drinking water according to claim 11, wherein the apparatus for supplying drinking water has a cleaning/sterilizing chamber for the water receptacle, a door for opening and closing the cleaning/sterilizing chamber, and a locking device for locking the door in a closed state when the cleaning/sterilizing device is operated.

20. The apparatus for supplying drinking water according to claim 12, wherein the apparatus for supplying drinking water has a cleaning/sterilizing chamber for the water receptacle, a door for opening and closing the cleaning/sterilizing chamber, and a locking device for locking the door in a closed state when the cleaning/sterilizing device is operated.

21. The apparatus for supplying drinking water according to claim 11, wherein the apparatus for supplying drinking water has an automatic cooler capable of cooling a hot beverage in the water receptacle to a desired temperature.

22. The apparatus for supplying drinking water according to claim 12, wherein the apparatus for supplying drinking water has an automatic cooler capable of cooling a hot beverage in the water receptacle to a desired temperature.
